(19) United States
(12) Patent Application Publication
(10) Pub. No.: US 2025/0154341 A1
(43) Pub. Date: May 15, 2025

(54) BIO-BASED HDPE FOR MONOCOMPONENT NON-WOVEN APPLICATION

(71) Applicant: Braskem S.A., Camaçari (BR)

(72) Inventors: Camila Pilatti Mainka, São Paulo (BR); Daniel Reinhard Sander, São Paulo (BR)

(73) Assignee: Braskem S.A., Camaçari (BR)

(21) Appl. No.: 18/946,307

(22) Filed: Nov. 13, 2024

Related U.S. Application Data
(60) Provisional application No. 63/599,429, filed on Nov. 15, 2023.

(51) Int. Cl. C08K 5/3492; C08K 3/22; C08K 5/527

(52) U.S. Cl. CPC C08K 5/34924; C08K 3/22; C08K 5/527; C08K 2003/2224

(57) ABSTRACT

A polymer composition may include a high-density polyethylene (HDPE), in which at least a portion of ethylene from the HDPE is obtained from a renewable source of carbon. The polymer composition may include a primary antioxidant that is an isocyanurate, a secondary antioxidant that comprises a diphosphite, and a neutralizer is a layered double hydroxide. A monocomponent fiber may include the polymer composition. An article may be prepared from the polymer composition or the monocomponent fiber. A product may be prepared from the polymer composition or the monocomponent fiber.

### CROSS-REFERENCE TO RELATED APPLICATIONS

This application claims priority to U.S. provisional application No. 63/599,429 filed on Nov. 15, 2023, the whole content of said application being incorporated herein by reference for all purposes.

### BACKGROUND

Polyolefins such as polyethylene (PE) and polypropylene (PP) may be used to manufacture a varied range of articles, including films, molded products, foams, and the like. Polyolefins may have characteristics such as high processability, low production cost, flexibility, low density and recycling possibility. However, physical and chemical properties of polyolefin compositions may exhibit varied responses depending on a number of factors such as molecular weight, distribution of molecular weights, content and distribution of comonomer (or comonomers), method of processing, and the like.

Methods of manufacturing may utilize polyolefin's limited inter- and intra-molecular interactions, capitalizing on the high degree of freedom in the polymer to form different microstructures, and to modify the polymer to provide varied uses in a number of technical markets. However, polyolefin materials may have a number of limitations, which can restrict application such as susceptibility to deformation and degradation in the presence of some chemical agents or heat. Property limitations may hinder the use of polyolefin materials in the production of articles requiring absorbency, resilience, liquid repellency, stretchability, strength, softness, flame retardancy, cushioning, washability, bacterial barriers, filtering, and sterility.

Commercial compositions of high-density polyethylene (HDPE) may be formulated with a variety of additives to tune performance based on the final application. For example, conventional HDPE compositions that are normally used in non-woven applications require specific material additives in order to achieve the attributes necessary for the application, leading to the production of complex and specialized mixtures.

In addition to complex formulations containing a number of additives, an additive package in a HDPE formulation is specific to a particular grade of HDPE. Some grades of HDPE are suitable for injection molding and may even be suitable for a non-woven application. However, when conventional HDPE compositions are applied to non-woven applications, they perform poorly and inconsistently while exhibiting further limitations as previously described.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polymer composition that includes a high-density polyethylene (HDPE), in which at least a portion of ethylene from the HDPE is obtained from a renewable source of carbon. The polymer composition may include a primary antioxidant that is an isocyanurate, a secondary antioxidant that comprises a diphosphite, and a neutralizer that is a layered double hydroxide.

In another aspect, embodiments disclosed herein relate to a monocomponent fiber that may include the polymer composition according to one or more embodiments.

In another aspect, embodiments disclosed herein relate to an article that may be prepared from the polymer composition or the monocomponent fiber according to one or more embodiments.

In another aspect, embodiments disclosed herein relate to a product that may be prepared from the polymer composition or the monocomponent fiber according to one or more embodiments.

Other aspects and advantages of the claimed subject matter will be apparent from the following description and the appended claims.

### BRIEF DESCRIPTION OF DRAWINGS

FIGS. 1A-1F depict Van Gurp-Palmen plots showing thermorheological data according to one or more embodiments of the present disclosure.

FIG. 2A shows solid cross-sectional area monocomponent fiber geometry, according to one or more embodiments.

FIG. 2B shows hollow cross-sectional area monocomponent fiber geometry, according to one or more embodiments.

FIGS. 3A-3F show different cross-sectional geometries of a monocomponent fiber that may be formed from the polymer composition according to one or more embodiments.

### DETAILED DESCRIPTION

In one aspect, embodiments disclosed herein relate to a polymer composition that includes a high-density polyethylene (HDPE), in which at least a portion of ethylene from the HDPE is obtained from a renewable source of carbon. The polymer composition may include a primary antioxidant that is an isocyanurate, a secondary antioxidant that comprises a diphosphite, and a neutralizer that is a layered double hydroxide.

Such HDPE compositions may provide enhanced properties, such as improved thermal stability or less susceptibility to thermal degradation; less die-buildup, dripping, and plugging upon use; and less migration of additives to the surface, particularly in non-woven applications. In contrast, conventional HDPE formulations do not provide suitable thermal protection, or result in additive migration, die-buildup in the spinneret, dripping, plugging of filter screens, and other complications that reduce efficiency and increase production costs of articles made with conventional HDPE formulations. These drawbacks limit the ability to change formulations or reuse HDPE for different applications, such as non-woven applications. The processing difficulty with HDPE and a traditional additive package that may include antioxidants such as tetraphenolic and monophosphites compounds, and neutralizers such as stearate salts, has motivated the search for alternative additive materials in HDPE compositions for enhanced properties, such as improved thermal stability; less die-buildup, dripping, and plugging upon use; and less migration of additives to the surface.

In particular, some conventional HDPE compositions cannot be used in non-woven applications as they are formulated with additives for other processes, such as injection molding. When these conventional HDPE compositions are used in non-wovens, die buildup in the spinneret, dripping, plugging of the filter screens and holes in non-wovens may result. The die-buildup in the spinneret, dripping, and/or plugging of filter screens may create holes in a non-woven material and affect quality control. Advantageously, a polymer composition according to one or more embodiments of the present disclosure provides less deposition (not limited to less deposits and build up in the spinneret) compared to a conventional HDPE composition.

Advantageously, the polymer composition according to one or more embodiments results in less additive migration than a conventional HDPE composition. Additive migration is also known as “blooming.” Blooming is a process in which one component of a polymer mixture, usually not a polymer, undergoes separation and migration to the external surface of the mixture. Thus, additive migration or blooming is a condition related to the solubility of the additive (components or molecules) in the polymer in combination with its diffusion rate to the surface. Hence, additive migration or blooming is the product of both the additive's solubility and its diffusion coefficient. Solubility of an additive in a polymer composition may be temperature dependent and may be a thermodynamic parameter, predictive of whether or not blooming may occur. Diffusion coefficient of an additive in a polymer composition may be a kinetic parameter that can indicate how much time the additive will take to migrate or bloom. Without wanting to be bound by theory, migration of an additive may relate to the molecular weight (molar mass) of the additive. Additive migration may be greater for a lower molecular weight additive compared to a higher molecular weight additive because the diffusion rate (coefficient) decreases as the additive's molecular weight increases.

Conventional HDPE compositions may be susceptible to degradation at high temperatures, such as temperatures up to 200, 210, 220, or 230° C. Advantageously, a polymer composition according to one or more embodiments of the present disclosure provides improved stability at high temperatures (less susceptibility to thermal degradation) such as temperatures up to 200, 210, 220, or 230° C., compared to a conventional HDPE composition. The combination of additives according to one or more embodiments includes a ratio of additive components that may individually or collectively have a greater molecular mass and/or thermal stability compared to additive combinations that are included in conventional HDPE compositions. Improved stability is not limited to a decrease in resin degradation, resin cross linking, visual defects, gels, black material (where black dye may not be present), and holes.

The polymer composition according to one or more embodiments of the present disclosure includes a neutralizer that neutralizes the catalyst residue more effectively than conventional HDPE compositions.

### Polymeric Composition Comprising HDPE

Polymer compositions in accordance with one or more embodiments of the present disclosure may be an HDPE (or HDPE-based) composition prepared from a HDPE polymer and an additive mixture. The additive mixture may be prepared from an antioxidant and a neutralizer. The antioxidant may include a primary and a secondary antioxidant. In one or more embodiments, the HDPE polymer composition is developed for non-woven articles and products.

### HDPE Polymer

Polymer compositions in accordance with one or more embodiments of the present disclosure include a high-density polyethylene.

In one or more embodiments, the high-density polyethylene may be present in an amount, with respect to the total weight of the composition, ranging from a lower limit of any of 80 wt %, 83 wt %, 85 wt %, 87 wt %, 90 wt %, 93 wt %, 95 wt %, 96 wt %, 97 wt %, 98 wt %, 99 wt %, 99.5 wt % to an upper limit of any of 90 wt %, 95 wt %, 97 wt %, 98 wt %, 99 wt %, 99.5 wt %, 99.6 wt %, 99.7 wt %, 99.8 wt %, 99.9 wt %, 99.99 wt %, where any lower limit can be used in combination with any mathematically allowed upper limit.

The HDPE polymer may be a granulate that is characterized by high rigidity and hardness, and a resin that has good melt flow (flowability). Due to its good flowability, the HDPE polymer according to one or more embodiments may advantageously be processed easily and with high productivity.

The high-density polyethylene may be polymerized by any method suitable to obtain the desired properties. In one or more embodiments, the high-density polyethylene is polymerized in the presence of a Ziegler-Natta catalyst in a single reactor or in one or more serially connected polymerization reactors. Any suitable polymerization process known in the art may be used to produce the HDPE such as polymerization in gas-phase, solution, slurry, and combinations thereof. In particular embodiments, the HDPE may be produced in a gas phase polymerization reactor.

In one or more embodiments, the HDPE may be a homopolymer, formed from ethylene or a copolymer of ethylene and one or more C3-C10 alpha olefin monomers, such as 1-butene, 1-hexene or 1-octene comonomers. In particular embodiments, HDPE may be a copolymer of ethylene and 1-butene.

In embodiments including a comonomer, the one or more C3-C10 alpha olefin comonomers may range from a lower limit selected from one of 0.01 mol %, 0.1 mol %, 0.5 mol %, 1.0 mol %, and 2.0 mol % to an upper limit selected from one of 3.0 mol %, 3.5 mol %, 4.0 mol %, 4.5 mol %, and 5.0 mol % of the total number of moles of the HDPE, where any lower limit may be paired with any upper limit. Comonomer content can be measured by ¹³C-NMR spectroscopy.

Thus, the HDPE may have an ethylene content ranging from a lower limit selected from one of 95 mol %, 95.5 mol %, 96 mol %, 96.5 mol %, and 97 mol % to an upper limit from one of 98 mol %, 99 mol %, 99.5 mol %, 99.9 mol %, 99.99 mol %, and 100 mol % of the total number of moles of the ethylene-based polymers, where any lower limit may be paired with any upper limit. Ethylene content can be measured by ¹³C-NMR spectroscopy.

Comonomer content measurement by ¹³C-NMR spectroscopy may be performed using a Bruker 500 MHz standard bore magnet with a Bruker Avance III HD console and a Bruker DUL-10 mm helium cooled CyroProbe (Bruker Corporation, Billerica, MA, USA). The measurement is carried out 1024 integrated times. The peak (30 ppm) of a main chain methylene is employed as the chemical shift standard. 200 mg of a specimen and 2.5 ml of a liquid mixture of extra pure grade o-dichlorobenzene produced by Sigma-Aldrich® (MilliporeSigma, St. Louis, MO, USA) and TCE-d produced by Sigma-Aldrich® in 3:1 (volume ratio) are put to a quartz glass tube of 10 mm diameter for NMR measurement sold at a market and heated at 120° C., and the specimen is evenly dispersed in the solvents to carry out the measurement.

In one or more embodiments, the HDPE may have a density, according to ASTM D792, ranging from a lower limit selected from one of 0.940, 0.942, 0.945, 0.947, 0.949, or 0.951 g/cm³ to an upper limit selected from one of 0.955, 0.958, 0.960, 0.962, 0.965, or 0.970 g/cm³ where any lower limit may be paired with any upper limit.

In one or more embodiments, the HDPE may have a melt flow rate (MFR), according to ASTM D1238 at 190° C./2.16 kg (at 190° C. and a load of 2.16 kg), ranging from a lower limit selected from one of 10, 12, 15, or 18 g/10 min to an upper limit selected from one of 30, 32, 35, 38, or 40 g/10 min, where any lower limit may be paired with any upper limit.

Polymer compositions in accordance with the present disclosure may include an HDPE polymer, wherein the number average molecular weight (Mn) in kilodaltons (kDa) of the HDPE polymer ranges from a lower limit selected from one of 6.0, 6.5, 7.0, 7.5, or 7.6 kDa, to an upper limit selected from one of 7.9, 8.0, 8.5, 9.0, or 9.5 kDa, where any lower limit may be paired with any upper limit.

Polymer compositions in accordance with the present disclosure may include a HDPE polymer, wherein the weight average molecular weight (Mw) in kilodaltons (kDa) of the HDPE polymer ranges from a lower limit selected from one of 45, 50, 55, 56, 57, 58, or 59 kDa to an upper limit selected from one of 63, 64, 65, 68, 70, 73, or 75 kDa, where any lower limit may be paired with any upper limit.

In one or more embodiments, the high-density polyethylene polymer may have a z-average molecular weight (Mz) ranging from a lower limit selected from one of 320, 330, 340, 350, 360, 365, 370, 375, 376, 377, 378, or 379 kDa, to an upper limit selected from one of 447, 478, 479, 480, 485, 490, 495, or 500 kDa, where any lower limit can be used in combination with any upper limit.

Polymer compositions in accordance with the present disclosure may include a HDPE polymer, wherein the molecular weight distribution (Mw/Mn) of the HDPE polymer ranges from a lower limit selected from one of 6.0, 6.5, 7.0, 7.5, 7.6, or 7.7 to an upper limit selected from one of 8.3, 8.4, 8.5, 9.0, or 9.5, where any lower limit may be paired with any upper limit.

Molecular weight analysis is carried out by gel permeation chromatography (GPC). In one or more embodiments, the GPC experiments may be carried out by gel permeation chromatography coupled with triple detection, with an infrared detector IR5 and a four-bridge capillary viscometer (Polymer Char, Valencia, Spain) and an eight-angle light scattering detector (Wyatt Technology Corporation, Santa Barbara, California, USA). A set of 4 mixed bed, 13 m columns (Agilent Technologies, Santa Clara, California, USA) may be used at a temperature of 150° C. The experiments may use a concentration of 1 mg/mL, a flow rate of 1 mL/min, a dissolution temperature and time of 160° C. and 90 minutes, respectively, an injection volume of 200 μL, and a solvent of 1,2,4-trichlorobenzene stabilized with 300 ppm of BHT.

In one or more embodiments, the high-density polyethylene may include polymers generated from petroleum based monomers and/or bio-based monomers (such as ethylene obtained from sugarcane derived ethanol). Commercial examples of bio-based polyolefins are the “I'm Green”™ line of bio-polyethylenes from Braskem S.A (Braskem S.A., Triunfo, Brazil).

In one or more embodiments of the present disclosure, it is envisioned that the HDPE may comprise ethylene derived from fossil origin in combination with ethylene derived from renewable sources. Bio-based HDPE is an HDPE wherein at least the ethylene monomers may be derived from renewable sources, such as ethylene derived from bio-based ethanol. Of the total amount of ethylene that makes up the HDPE, it is understood that at least a portion of that ethylene is based on a renewable carbon source.

Specifically, in one or more embodiments, the HDPE polymer exhibits a bio-based carbon content, as determined by ASTM D6866-18 “Standard Test Methods for Determining the Biobased Content of Solid, Liquid, and Gaseous Samples Using Radiocarbon Analysis.” of at least 5%. Further, other embodiments may include at least 10%, 20%, 40%, 50%, 60%, 80%, 85%, 90%, 91%, 92%, 93%, 94%, 95%, 96%, 97%, 98%, 99%, or 100% bio-based carbon. In one or more embodiments, the HDPE polymer may have a minimum bio-based carbon content of 94%, determined according to ASTM D6866. As mentioned above, the total bio-based or renewable carbon in the HDPE polymer may be contributed from a bio-based ethylene.

For example, in one or more embodiments, the renewable source of carbon is one or more plant materials selected from the group consisting of sugar cane and sugar beet, maple, date palm, sugar palm, sorghum, American agave, corn, wheat, barley, sorghum, rice, potato, cassava, sweet potato, algae, fruit, materials comprising cellulose, wine, materials comprising hemicelluloses, materials comprising lignin, wood, straw, sugarcane bagasse, sugarcane leaves, corn stover, wood residues, paper, and combinations thereof.

In one or more embodiments, the bio-based ethylene may be obtained by fermenting a renewable source of carbon to produce ethanol, which may be subsequently dehydrated to produce ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Thus, biologically sourced ethanol, known as bio-ethanol, is obtained by the fermentation of sugars derived from cultures such as that of sugar cane and beets, or from hydrolyzed starch, which is, in turn, associated with other cultures such as corn. It is also envisioned that the bio-based ethylene may be obtained from hydrolysis based products from cellulose and hemi-cellulose, which can be found in many agricultural by-products, such as straw and sugar cane husks. This fermentation may be carried out in the presence of various microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina.

An exemplary route of obtaining a bio-based ethylene is described as follows. Initially, a fermentation of a renewable starting material, including those described above, and optional purification, may produce at least one alcohol (either ethanol or a mixture of alcohols including ethanol). The alcohol may be separated into two parts, where the first part is introduced into a first reactor and the second part may be introduced into a second reactor. In the first reactor, the alcohol may be dehydrated in order to produce an alkene (ethylene or a mixture of alkenes including ethylene, depending on whether a purification followed the fermentation) followed by optional purification to obtain ethylene. One of ordinary skill in the art may appreciate that if the purification occurs prior to dehydration, then it need not occur after dehydration, and vice versa. The present disclosure is not so limited in terms of the route of forming bio-based ethylene for HDPE. Further methods of forming bio-based ethylene would be appreciated by one of ordinary skill in the art.

In one or more embodiments, the bio-based high-density polyethylene may exhibit an emission factor in a range from −3.5 kg CO₂ₑ/kg (kilogram of carbon dioxide equivalent per kilogram) of the bio-based high-density polyethylene to 0 kg CO₂ₑ/kg of the bio-based high-density polyethylene.

As disclosed herein, the Emission Factor of a polymer composition comprising the bio-based high-density polyethylene may be calculated according to the international standard ISO 14044:2006—“ENVIRONMENTAL MANAGEMENT—LIFE CYCLE ASSESSMENT—REQUIREMENTS AND GUIDELINES.” The boundary conditions consider the cradle to gate approach. Numbers are based on peer reviewed LCA ISO 14044 compliant study and the environmental and life cycle model are based on SimaPro® software (SimaPro, Amersfoort, Utrecht, The Netherlands). Ecoinvent (Ecoinvent, Zurich, Switzerland) is used as background database and IPCC 2013 GWP100 is used as LCIA method. For example, a life cycle analysis of the steps involved in the production of a bio-based high-density polyethylene from sugarcane may involve Emission Factors calculated for each step, as shown in Table 1.

TABLE 1
Sample calculation of an Emission Factor for the production
of a bio-based high-density polyethylene

| | | Emission Factor |
|---|---|---|
| Impact Category | Resin | (kg CO₂ₑ/kg resin) |
| Sugarcane | Agricultural operations | 0.91 |
| production | Land use change credits | −1.10 |
| | CO₂ Uptake | −3.14 |
| | Subtotal | −3.33 |
| Ethanol | Ethanol production | 0.03 |
| Production | Bagasse burning | 0.16 |
| | Electricity cogeneration | −1.17 |
| | credits | |
| | Subtotal | −0.98 |
| Bio-based | Ethanol transport | 0.46 |
| HDPE Production | Industrial Operations | 0.76 |
| | (Ethylene and PE) | |
| | Subtotal | 1.22 |
| | TOTAL | −3.09 |

### Additives

Polymer compositions in accordance with one or more embodiments may incorporate one or more additives. The additives may include but are not limited to an antioxidant and a neutralizer. An antioxidant may include a primary and a secondary antioxidant.

The primary antioxidant may include a triazine. The triazine may be one or more selected from the group consisting of 1,2,3-triazine, 1,2,4-triazine, 1,3,5-triazine, and a combination thereof.

The primary antioxidant may include one or more hydroxyl groups on a triazine. For example, the primary antioxidant may be an isocyanurate (cyanuric acid). In one or more embodiments, the primary antioxidant may be an isocyanurate represented by formula I, as shown below.

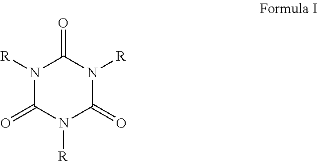

In Formula I, R may be the same or different benzyl group (C₆H₅CH₂—). The benzyl group may comprise (further substituted with) one or more alkyl group and a hydroxyl group on the benzylic aromatic ring (of the benzyl group). In one or more embodiments, the benzylic aromatic ring of the benzyl group is substituted with one or more alkyl groups and a single hydroxyl group. In one or more embodiments, an alkyl group may range from 1 to 4 carbons. An alkyl group may include one or more of a methyl, an ethyl, a propyl, a butyl, or a combination thereof. A propyl may be n-propyl, isopropyl, or a combination thereof. A butyl may be n-butyl, sec-butyl, isobutyl, tert-butyl, or a combination thereof.

Examples of suitable primary antioxidant include but are not limited to tris(4-tert-butyl-3-hydroxy-2,6-dimethylbenzyl) isocyanurate (CAS number: 40601-76-1), tris(3,5-di-tert-butyl-4-hydroxybenzyl) isocyanurate (CAS number: 27676-62-6), and a combination thereof.

In one or more embodiments, the primary antioxidant has a concentration range from a lower limit selected from one of 270, 275, 280, 285, and 290 parts per million (ppm), to an upper limit selected from one of 310, 320, 330, 350, 375, 400, 425, and 450 ppm of the total polymer composition, where any lower limit may be paired with any upper limit.

In one or more embodiments, the primary antioxidant has a molecular weight from a lower limit selected from one of 650, 675, 680, 685, and 690 grams per mole (g/mol), to an upper limit selected from one of 700, 710, 725, 740, and 750 g/mol, where any lower limit may be paired with any upper limit.

When the polymer composition includes isocyanurate as a primary antioxidant according to one or more embodiments of the present disclosure, benefits include lower volatility (of the primary antioxidant) at high processing temperatures, resistance to discoloration and gas fading, and lower odor, compared to a polymer composition without isocyanurate as a primary antioxidant.

The secondary antioxidant may include one or more components. The secondary antioxidant may include a diphosphite. The diphosphite may be a first component of the secondary antioxidant. The secondary antioxidant may include a pentaerythritol-diphosphite. In one or more embodiments, the secondary antioxidant may include or may be a diphosphite represented by formula II, as shown below.

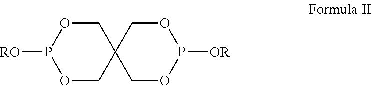

In Formula II, R may be an aromatic group. The aromatic group may comprise (further substituted with) one or more alkyl group (at least one alkyl group). The aromatic group may comprise (further substituted with) at least one alkyl group and another aromatic ring on the aromatic group. For example, —OR may include a phenyl or a cumylphenol functional group. Cumylphenol may include but is not limited to 2-cumylphenol, 3-cumylphenol, 4-cumylphenol, 2,4-dicumylphenol, and 2,4,6-tricumylphenol. The phenyl or cumylphenol functional group may be further substituted with an alkyl or aromatic group. An alkyl group (or additional alkyl groups) of the phenyl or cumylphenol functional group may range from 1 to 4 carbons. An alkyl group may include one or more of a methyl, an ethyl, a propyl, a butyl, or a combination thereof. A propyl may be n-propyl, isopropyl, or a combination thereof. A butyl may be n-butyl, sec-butyl, isobutyl, tert-butyl, or a combination thereof.

Examples of a suitable secondary antioxidant include but are not limited to bis(2,4-dicumylphenyl)pentaerythritol diphosphite (CAS number: 154862-43-8), bis(2,4-di-tert-butylphenyl)pentaerythritol diphosphite (CAS number: 97994-11-1), and a combination thereof.

In one or more embodiments, the diphosphite secondary antioxidant has a molecular weight from a lower limit selected from one of 600, 700, 725, 750, 775, 800, 825, and 840 grams per mole (g/mol), to an upper limit selected from one of 860, 870, 880, 890, and 900 g/mol, where any lower limit may be paired with any upper limit.

The secondary antioxidant may include a second component. When the secondary antioxidant includes a second component, it may be an amine base comprising an alkyl and a hydroxyl group. The amine base may be a tertiary amine base. Suitable examples of an amine base may include but are not limited to trimethanolamine (CAS number: 14002-32-5), triethanolamine (CAS number: 102-71-6), triisopropanolamine (CAS number: 122-20-3), and a combination thereof.

When the secondary antioxidant includes two components, a first component may have a concentration of greater than or equal to 98 weight %, 99 weight %, 99.5 weight %, 99.9 weight %, or 99.99 weight % of the total weight of the secondary antioxidant. When the secondary antioxidant includes two components, a second component may have a concentration of less than or equal to 2 weight %, 1 weight %, 0.5 weight %, 0.1 weight %, or 0.01 weight % of the total weight of the secondary antioxidant.

In one or more embodiments, the secondary antioxidant ranges from a lower limit selected from one of 500, 550, 600, 650, 700, 750, 800, 850, 900, 950, 975, and 990 ppm, to an upper limit selected from one of 1100, 1125, 1150, 1200, 1250, 1300, 1350, 1400, 1450, and 1500 ppm of the total polymer composition, where any lower limit may be paired with any upper limit.

The neutralizer may include a layered double hydroxide. The neutralizer may include magnesium and aluminum. The neutralizer may include a carbonate ion. An example of a suitable neutralizer includes but is not limited to hydrotalcite. Hydrotalcite may have a chemical formula Mg₆Al₂CO₃(OH)₁₆·4H₂O. One of ordinary skill in the art would appreciate the various forms of hydrotalcite that may be included as a neutralizer.

In one or more embodiments, the neutralizer has a concentration range from a lower limit selected from one of 150, 200, 250, 260, 270, 280, and 290 parts per million (ppm), to an upper limit selected from one of 310, 320, 330, 350, 375, 400, 425, and 450 ppm of the total polymer composition, where any lower limit may be paired with any upper limit.

In one or more embodiments, the neutralizer has a molecular weight from a lower limit selected from one of 400, 425, 450, 475, and 490 grams per mole (g/mol), to an upper limit selected from one of 500, 525, 550, 575, and 600 g/mol, where any lower limit may be paired with any upper limit.

In one or more embodiments, the neutralizer has an average particle size ranging from a lower limit selected from one of 0.30, 0.35, 0.40, 0.43, and 0.45 micrometers (μm), to an upper limit selected from one of 0.53, 0.55, 0.60, 0.65, and 0.70 μm.

In conventional compositions comprising HDPE, water carry-over may occur when an additive migrates to the surface and causes an increase in water adhesion. Polymer compositions according to one or more embodiments of the present disclosure, with a neutralizer such as hydrotalcite, result in less water carry-over and less additive migration to the surface, compared to polymer compositions that have a conventional neutralizer (including but not limited to metal stearates).

### Properties

In one or more embodiments, the polymer composition may have a density, according to ASTM D792, ranging from a lower limit selected from one of 0.940, 0.942, 0.945, 0.947, 0.949, and 0.951 g/cm³ to an upper limit selected from one of 0.955, 0.958, 0.960, 0.962, 0.965, and 0.970 g/cm³, where any lower limit may be paired with any upper limit.

In one or more embodiments, the polymer composition may have a melt flow rate (MFR), according to ASTM D1238 at 190° C./2.16 kg, ranging from a lower limit selected from one of 10, 12, 15, and 18 g/10 min to an upper limit selected from one of 30, 32, 35, 38, and 40 g/10 min, where any lower limit may be paired with any upper limit.

In one or more embodiments, the polymer composition may present a thermal stability (or is thermally stable) up to at least 230° C. verified through thermorheological method (Van Gurp-Palmen plot). In another one or more embodiments, the polymer composition may present a thermal stability (or is thermally stable) up to 230° C. verified through thermorheological method (Van Gurp-Palmen plot). Van Gurp and Palmen proposed the plot of the phase angle (delta) as a function of the complex modulus delta(|G*|) as a first qualitative check for the thermorheological behavior. In the case of a thermorheologically simple fluid, no temperature dependence of the function of delta(|G*|) should occur, while a thermorheological complexity should lead to a temperature dependence of the shape of delta(|G*|). Linear and short-chain branched PE exhibits the simple thermorheological behavior, which means that the curves at different temperatures are superposed to each other. Since PE chain structure is altered during its degradation, thermorheological methods can be used to investigate PE degradation. Further details of Van Gurp-Palmen plots may be found in the following references: van Gurp, M. and Palmen, J., “Time-Temperature Superposition for Polymeric Blends,” Rheology Bulletin (1998), 67, pages 5-8; and Stadler, F. J., et al., “Thermorheological Behavior of Various Long-Chain Branched Polyethylenes,” Macromolecules (2008), 41, pages 1328-1333.

In one or more embodiments, the polymer composition may have a gel level count per unit area of less than 150 gels/m² for a CAT 1 class (201-500 μm). In one or more embodiments, the polymer composition may have a gel level count per unit area of less than 10 gels/m² for a CAT 2 class (501-1000 μm). In one or more embodiments, the polymer composition may have a gel level count per unit area of 0 gel/m² for a size greater than 1000 m. A quantity of “gels” (or gel rating) may be identified and quantified using an OCS (Optical Control Systems®, Witten, Germany) Gel Counting Apparatus, such as a Measuring Extruder Model ME20-2800-V3, chill roll unit model CR9. Identification of gels with OCS instrumentation may use films with a thickness of 38±5 m, extruded at a temperature profile of 170/180/190/200/210° C. The OCS system evaluates slightly over 1.0 m² of film per test. The OCS system, at the completion of each test, generates a summary of the gel data per 1.0 m² of film. The count or quantity of gel levels, per unit area was measured, 1.0 m² area was inspected, based on counts gel size in four classes: CAT 1 class (201-500 μm), CAT 2 class (501-1000 μm), CAT 3 class (1001-1500 μm), and CAT 4 class (>1500 μm).

Gels are a common quality problem in extrusion of film and tubing. Gels may be visual defects caused by small bits of greater-molecular-weight material or contamination that may reflect and transmit light differently from the rest of the material. Gels may arise from formulation (additives that may cause gelling), contamination, processing (such as extruding), and other sources of gel formation. Advantageously, a polymer composition according to one or more embodiments of the present disclosure provides improved gelling (less gels) compared to a conventional HDPE composition.

### Preparation

Polymeric compositions in accordance with the present disclosure may be prepared in any conventional mixture device. In one or more embodiments, polymeric compositions may be prepared by mixture in conventional kneaders, banbury mixers, mixing rollers, twin screw extruders, and the like, in conventional HDPE processing conditions and subsequently arranged in a fiber, sheet, or web (expanded or extruded).

Conventional HDPE processing includes various manufacturing processes related to non-wovens include but are not limited to drylaid-carded, meltspun, flashspun, airlaid, short fiber airlaid, wetlaid (chemical), spunlaid, meltblown, submicron spun, thermal, hydroentangled, ultrasonic, needlepunched (or needlefelted), and a combination thereof.

In one or more embodiments, polymer compositions in accordance with the present disclosure may be prepared by a spun bonding process, also known as spunlaid or spunmelt bonding. A spunbound process may form a spunbound monocomponent (fiber) or a staple fiber with the polymer composition of one or more embodiments of the present disclosure.

A spun bonding process includes or consists of four simultaneous, integrated operations: filament extrusion, drawing, lay down, and bonding. In one or more embodiments, combined production stages may be used to provide different composite structures, such as a spunbond (S) and meltblown (M) process. Possible combinations include but are not limited to SMS, SMMS, and SSMMS. In one or more embodiments, non-wovens may be produced with a melt spinning technique.

The polymer composition passes through a spinneret where filaments are formed (extruded). The filaments are quenched when they leave the spinneret in a spun bonding process. The filaments of the spun bonding process hit a belt or conveyor belt. The conveyor belt carries the unbonded web to the bonding zone where a web may be formed. Techniques employed include but are not limited to thermal, chemical/adhesive, and mechanical bonding, or a combination thereof. The type of technique used may be dictated by the final application (such as a type of non-woven fabric that is to be produced) and the web weight. The temperature of the spun bonding process may range from about 200° C. to about 250° C.

The filament(s) may have a linear mass density in a range from 0.1 to 100 decitex (dtex), such as from 0.2 to 90 dtex, 0.3 to 80 dtex, 0.4 to 70 dtex, 0.5 to 65 dtex, 0.6 to 60 dtex, 0.7 to 55 dtex, and 0.8 to 50 dtex (0.07 to 45 denier). The non-woven fabric that is produced may be up to 5.2 meters (m) wide and usually not less than 3.0 m in width for acceptable productivity, however a person in the art may produce non-woven fabrics with different widths as necessary for a particular application.

A non-woven fabric formed from the polymer composition of one or more embodiments may have a weight per unit area in a range from 1 to 1000 grams per meter squared (g/m²), such as from 5 to 900 g/m², or from 10 to 800 g/m².

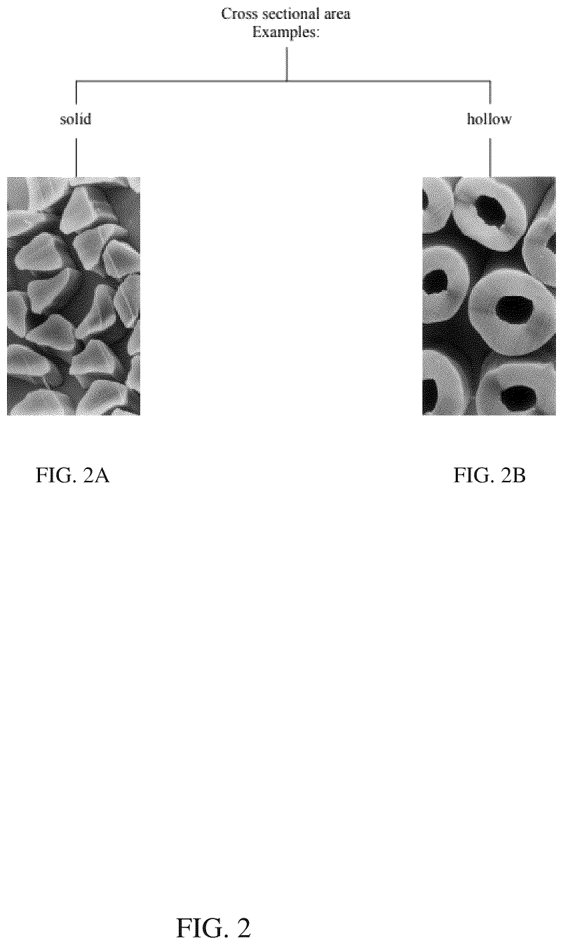

The polymer composition according to one or more embodiments may be used for production of a monocomponent fiber. FIGS. 2A-2B show geometries of cross-sectional area of a monocomponent fiber that may be formed from the polymer composition according to one or more embodiments. FIG. 2A shows an example of a solid cross-sectional area monocomponent fiber geometry and FIG. 2B shows an example of a hollow cross-sectional area monocomponent fiber geometry.

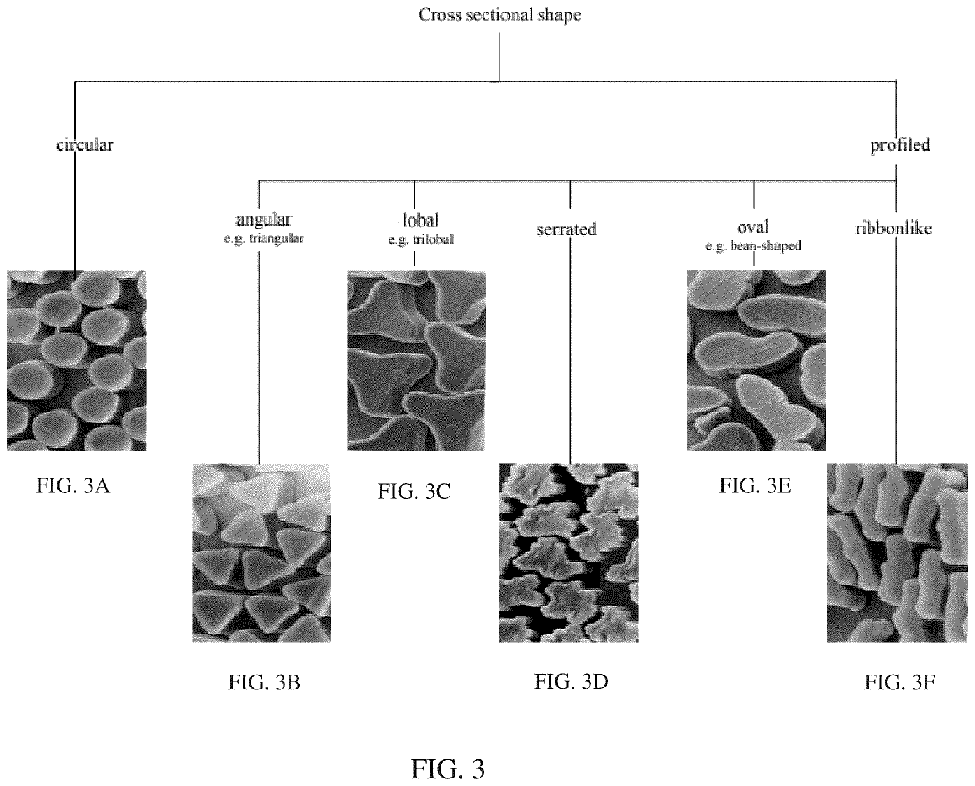

FIGS. 3A-3F show cross-sectional shapes of a monocomponent fiber according to one or more embodiments. The monocomponent fiber geometry may be generally circular, as shown in FIG. 3A or profiled as shown in FIGS. 3B-3F. For example, a profiled cross-sectional monocomponent fiber geometry may include, in FIG. 3B angular (e.g., triangular), in FIG. 3C lobal (e.g., trilobal), in FIG. 3D serrated, in FIG. 3E oval (e.g., bean-shaped), and in FIG. 3F ribbonlike cross-sectional geometry. The monocomponent fiber geometries shown in FIGS. 3A-3F may have a solid cross-sectional area or a hollow cross-sectional area, as depicted in FIGS. 2A and 2B, respectively.

### Applications

One or more embodiments of polymer compositions herein may be used in a non-woven application, article, and/or product, and a manufacturing process related to non-wovens. Non-wovens are also known as non-woven fabrics, articles, or products that may be sheet or web structures bonded together by entangling fiber or filaments (and by perforating films) mechanically, thermally, or chemically. Non-wovens are flat or tufted porous sheets that are made directly from separate fibers, molten plastic, or plastic film. Non-wovens are not made by weaving or knitting and do not require converting the fibers to yarn. Non-wovens may be single-use, limited life use, or may be durable for long life use. Non-wovens provide functions such as absorbency, liquid repellence, resilience, stretch, softness, strength, flame retardancy, washability, cushioning, thermal insulation, acoustic insulation, filtration, use as a bacterial barrier and sterility.

Polymer compositions in accordance with the present disclosure may be formulated for a number of polymer articles, including the production of non-woven articles that may be formed into products. Non-woven products may include but are not limited to hygiene, apparel, home furnishing, health care, medical, engineering, industrial, automotive, packaging, and consumer materials. Specific examples of products that may include non-woven articles include but are not limited to diaperstock, feminine hygiene products, absorbent materials, carpet, composites, backing and stabilizer for machine embroidery, packaging, shopping bags, insulation, acoustic insulation, pillows, cushions, mattress cores, upholstery, padding, batting in quilts or comforters, consumer and medical face masks, mailing envelopes, tarps, tents, transportation wrapping, disposable clothing, weather resistant house wrap, cleanroom wipes, potting material for plants, medical gowns, medical covers, medical masks, medical suits, medical caps, medical packaging, gloves, shoe covers, bath wipes, wound dressings, drug delivery products, plasters, geotextiles, and the like. Further products that may include non-woven articles include but are not limited to various filters for gasoline, oil, air, HEPA, water, coffee, tea bags, mineral processing, liquid cartridge and bags filters, vacuum bags, allergen membranes, and laminates.

Embodiments disclosed herein may have the following advantages. A monocomponent fiber of pure HDPE may be produced by fiber spinning. Typically, pure HDPE, for example, injection molding grades, are not able to be spun into fibers because the fiber breaks during processing even at the lowest cabin pressures, due its low thermal stability. Advantageously, the present invention differs from the market solution due to its higher density that provides good abrasion resistance and tensile strength.

### EXAMPLES

Table 2 shows polymer formulations for IE1 and IE2 according to one or more embodiments and for a commercially available injection molding HDPE grade, SHA 7260. The commercial grade SHA 7260 is included in Table 2 only for comparison; it is noted that SHA 7260 could not processed using the method described according to embodiments disclosed herein.

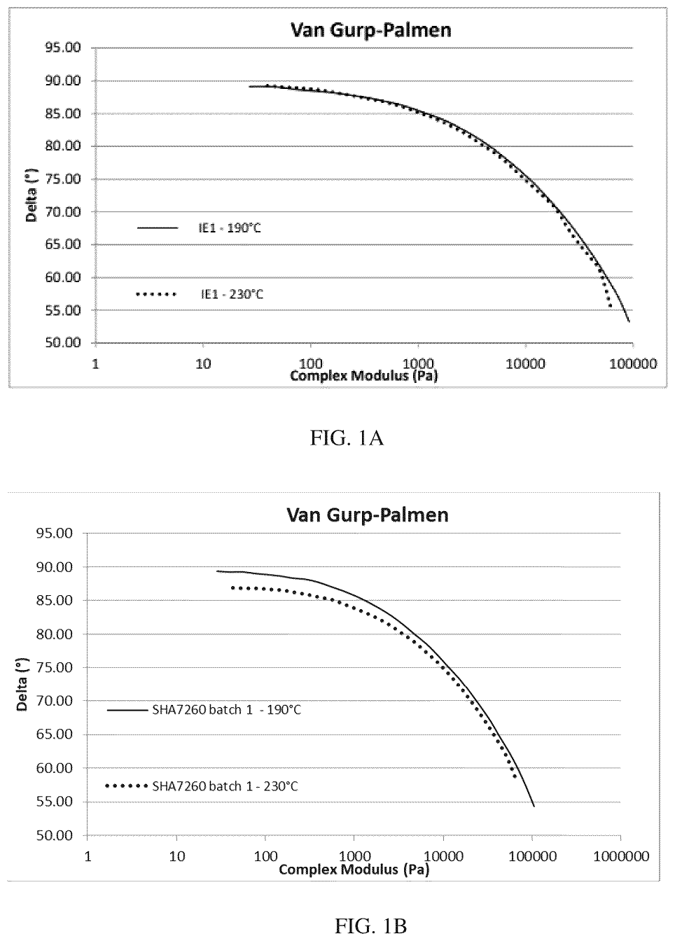

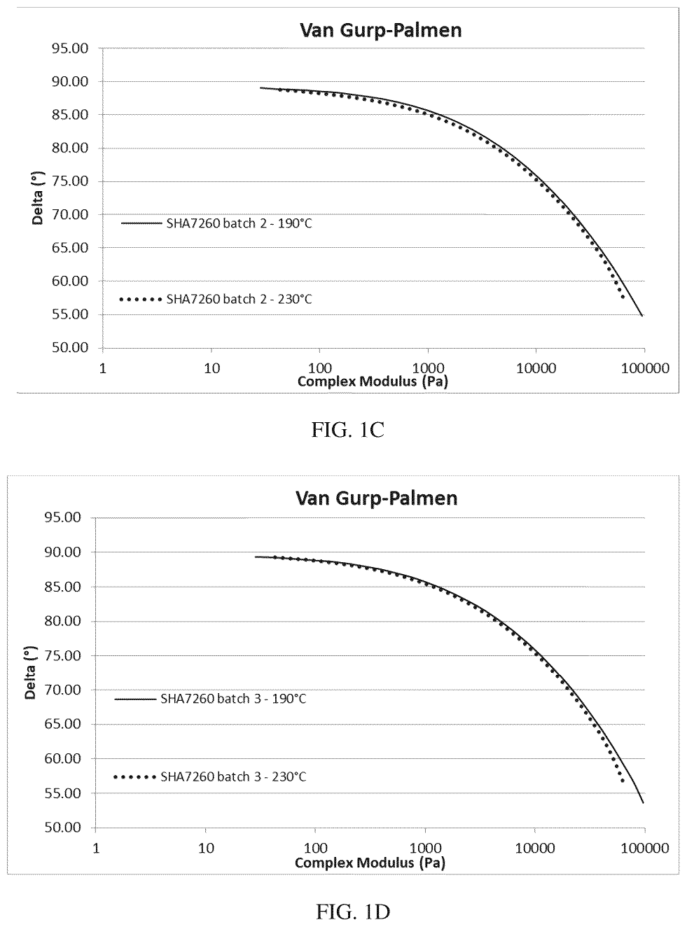

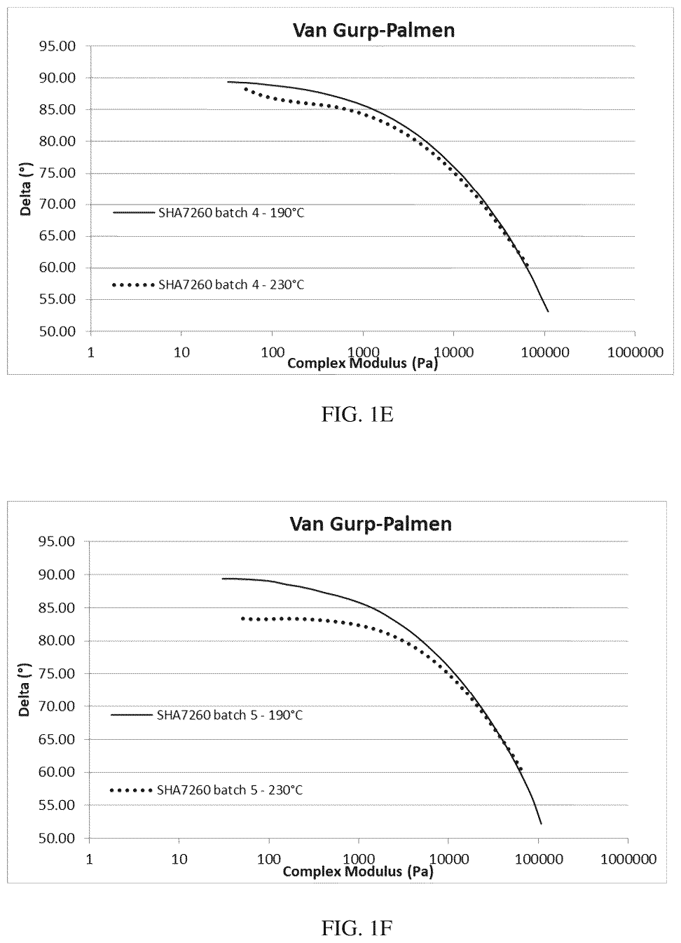

FIGS. 1A-1F show results of thermorheological analyses depicted in Van Gurp-Palmen (VGP) plots. The VGP plot shows phase angles (delta, ∘) versus absolute values of the complex shear modulus (Pascal) from thermorheological experiment(s).

Linear and short-chain branched PE exhibits the simple thermorheological behavior, which means that the curves at different temperatures are superposed to each other. Since PE chain structure is altered during its degradation, thermorheological methods can be used to investigate PE degradation.

The curves of the VGP plot show HDPE compositions at 190° C. and 230° C. When the curves of the same material are plotted at different temperatures in the VGP and these two curves overlap, then thermal degradation may not be present. 5 batches of a conventional HDPE composition (SHA7260) were tested at both 190° C. and 230° C., as shown in FIGS. 1B-1F. In some batches of the conventional composition, the VGP curves overlap, as shown in FIGS. 1C and 1D. In other batches of the conventional composition, the VGP curves do not overlap, as shown in FIGS. 1B, 1E, and 1F. The HDPE composition according to one or more embodiments was tested at both 190° C. and 230° C., resulting in consistent overlap from batch to batch, as shown in FIG. 1A. Only 1 batch of the polymer composition according to one or more embodiments is shown, as the results were substantially similar when tested across multiple batches.

Thus, the HDPE composition according to one or more embodiments provides thermal stability up to 230° C. Further, the thermal stability of the HDPE composition of one or more embodiments is consistently conveyed, compared to a conventional HDPE composition. This consistency in thermal stability from batch to batch results in improved cost savings as some batches of conventional HDPE compositions may need to be removed from processing, manufacture, or otherwise recycled or destroyed.

When FIG. 1A (VGP plot of the HDPE composition according to one or more embodiments) is compared to FIGS. 1B-1F (VGP plots of conventional HDPE compositions), the advantage in consistent thermal stability up to 230° C. is demonstrated. For example, across 5 batches of the comparative conventional HDPE composition, 3 of 5 batches may not provide suitable thermal stability up to 230° C. Meaning, 60% of the batches (3 of 5) of the conventional HDPE composition may not be suitable for further use in non-woven applications or production of non-wovens. Such a failure rate from batch to batch exhibited by conventional HDPE compositions is unsustainable and costly. Thus, the examples highlight deficiencies in conventional HDPE compositions for use in non-woven applications, where processing temperatures may be from about 200° C. to 250° C.

Inventive Example 1 (IE1) is a monocomponent high-density polyethylene (HDPE) fibers having a formulation according to Table 2. IE1 was spun on a Reicofil 4.5 Bicomponent Continuous Filament Fiber Spinning Line at a throughput rate of 0.54 ghm. A Hills Bicomponent die is used operating at a 70/30 core/sheath ratio with the same material fed into each extruder thereby forming monocomponent fibers. Extruder profiles are adjusted to achieve a melt temperature of 232° C. A line speed of 180 m/min was used to produce IE1. The process air parameters are set to reach 2000 Pa of cabin pressure. The Q1 and Q2 quench air ratio (Q1/Q2) are set at 95% and the temperatures at 22 and 20° C., respectively. The nonwoven fibers are bonded together by thermal bonding.

Inventive Example 2 (IE2) was fabricated using the formulation listed in Table 2 and using the same processing parameters as IE1, except that a line speed of 245 m/min was used for IE2.

TABLE 2
Formulation of HDPE.

| | HDPE according to one | Commercially available HDPE |
|---|---|---|
| | or more embodiments | (injection molding grade) |
| Material | IE1 and IE2 | SHA7260 |
| Bio-based carbon content | ≥94% | ≥94% |
| Density (g/cm³) | 0.952-0.958 | 0.952-0.958 |
| Melt flow rate (MFR) 190° C./2.16 kg | 16-24 | 16-24 |
| (g/10 min) | | |
| Mn (kDa) | 7.6-7.9 | 7.6-7.9 |
| Mw (kDa) | 59-63 | 59-63 |
| Mz (kDa) | 379-447 | 379-447 |
| Mw/Mn | 7.7-8.3 | 7.7-8.3 |
| Gels CAT 1 class (201-500 μm) | <150 | Not analyzed |
| (gels/m²) | | |
| Gels CAT 2 class (501-1000 μm) | <10 | Not analyzed |
| (gels/m²) | | |
| Gels CAT 3 class (1001-1500 μm) | 0 | Not analyzed |
| (gels/m²) | | |
| Gels CAT 4 class (>1500 μm) | 0 | Not analyzed |
| (gels/m²) | | |
| Pentaerythritol Tetrakis[3-(3,5-di- | — | 300 |
| tert-butyl-4-hydroxyphenyl)propionate] | | |
| Tris(2,4-di-tert-butylphenyl) phosphite | — | 300 |
| Calcium Stearate (ppm) | — | 700 |
| Tris(4-tert-butyl-3-hydroxy-2,6- | 300 | — |
| dimethylbenzyl) isocyanurate (ppm) | | |
| Bis(2,4-dicumylphenyl) pentaerythritol | 1000 | — |
| diphosphite (>98%) + | | |
| Triisopropanol amine (<1%) | | |
| Hydrotalcite (ppm) | 300 | — |

### Physical Properties

Monocomponent fibers IE1 and IE2 were characterized with several polymer characterization techniques and the results are shown in the Table 3 below. The Inventive fabric samples IE1 and IE2 were subject to tensile testing in machine direction (MD) and cross direction (CD), and measurement of fiber diameter, fineness, and fabric weight.

### Tensile Testing

The following procedures are used to generate tensile testing data for nonwoven fabrics of the present invention. Basis weight may be determined by measuring the weight of a known area of fabric.

A test specimen is clamped in a tensile testing machine with a clamping length of 10 cm×5 cm, a load cell of 500 N and the force is applied to extend the test specimen at a rate of 200 mm/min until it breaks. Values for the breaking force and elongation of the test specimen are obtained from a computer interface.

Peak tensile strength is the maximum or peak force applied to a material prior to rupture. Materials that are brittle usually rupture at the maximum force. Materials that are ductile usually experience a maximum force before rupturing. A high precision electronic test instrument is used that measures the elongation at break and peak tensile strength of materials while pulling forces are applied to the material. The force which is exerted on the specimen is read directly from the testing machine or graphs obtained during the test procedure. For each sample, at least 6 specimens were tested and the average was calculated and used for the peak tensile strength observed for the sample.

Elongation at Break is the deformation in the direction of load caused by a tensile force. Elongation is expressed as a ratio of the length of the stretched material as a percentage to the length of the unstretched material. Elongation at break is determined at the point where the stretched material breaks. The apparent elongation is determined by the increase in length from the start of the force-extension curve to a point corresponding with the breaking force, or other specified force. The apparent elongation is calculated as the percentage increase in length based on the gage length.

### Fiber Tensile Testing

The two different fabric weight fibers produced according to the specifications above were tested. Six specimens (MD and CD) with dimensions of 25 cm×5 cm have been punched out from each fabric and the replicates are run and the peak load is recorded as the maximum fiber tensile strength. The elongation at break is recorded as the maximum elongation.

### Filament Diameter and Fineness

For the determination of the diameter and fineness of the filament a specimen is cut out before calendering (unconsolidated nonwoven). Spunbonded fibers are generally continuous and larger than 7 microns in diameter, more particularly, they are usually between about 10 and 20 microns. The filament diameter is determined using an optical half automatic measurement system.

For a given material, the fiber fineness is directly linked to the filament diameter. It is calculated as the ratio between fiber mass and fiber length, being a direct measure of linear density of the fiber. The unit dtex (deci-tex) is equivalent to 1 g/10,000 m of yarn and the unit den (denier) is equivalent to 1 g/9,000 m of yarn. Fiber fineness affects the material's surface area, porosity, and filtration resistance, thereby indirectly determining the performance and applications of the fiber.

TABLE 3
Physical properties of IE1 and IE2.

| | HDPE according to one | HDPE according to one |
|---|---|---|
| | or more embodiments | or more embodiments |
| Material | IE1 | IE2 |
| Fabric weight (gsm) | 20.4 | 14.5 |
| Filament fineness (dtex) | 2.42 | — |
| Filament fineness (den) | 2.18 | — |
| Fialment diamenter (μm) | 18 | — |
| Tensile strength - MD (N) | 42.9 | 44.1 |
| Tensile strength - CD (N) | 4.7 | 2.9 |
| Elongation - MD (%) | 42.9 | 44.1 |
| Elongation - CD (%) | 54.6 | 35.9 |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed:

1. A polymer composition, comprising:
a high-density polyethylene (HDPE);
a primary antioxidant that is an isocyanurate;
a secondary antioxidant comprising a diphosphite; and
a neutralizer that is a layered double hydroxide.

2. The polymer composition of claim 1, wherein:
the primary antioxidant is in a range of from 270 to 450 parts per million (ppm) of the total polymer composition;
the secondary antioxidant is in a range of from 500 to 1500 ppm of the total polymer composition; and
the neutralizer is in a range of from 150 to 450 ppm of the total polymer composition.

3. The polymer composition of claim 1, wherein the secondary antioxidant further comprises a tertiary amine base comprising an alkyl and a hydroxyl group.

4. The polymer composition of claim 1, wherein:
the primary antioxidant is represented by formula I: 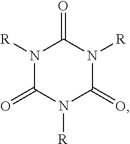
where R is a benzyl group further substituted with one or more alkyl group and a hydroxyl group on a benzylic aromatic ring;
the secondary antioxidant comprises a pentaerythritol-diphosphite represented by formula II: 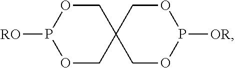
where R is an aromatic group further substituted with at least an alkyl group; and
the neutralizer comprises magnesium and aluminum.

5. The polymer composition of claim 1, wherein:
the secondary antioxidant comprises a pentaerythritol-diphosphite represented by formula II: 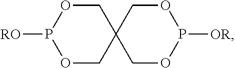
and
R is an aromatic group further substituted with at least an alkyl group and another aromatic ring on the aromatic group.

6. The polymer composition of claim 3, wherein the tertiary amine base comprises an alkyl and a hydroxyl group is triisopropanol amine.

7. The polymer composition of claim 1, wherein:
the primary antioxidant comprises one or more selected from the group consisting of tris(4-tert-butyl-3-hydroxy-2,6-dimethylbenzyl) isocyanurate and tris(3,5-di-tert-butyl-4-hydroxybenzyl) isocyanurate,
the secondary antioxidant comprises one or more selected from the group consisting of bis(2,4-dicumylphenyl)pentaerythritol diphosphite and bis(2,4-di-tert-butylphenyl)pentaerythritol diphosphite, and
the neutralizer is a hydrotalcite.

8. The polymer composition of claim 1, wherein:
the secondary antioxidant has a molecular weight from about 600 g/mol to about 900 g/mol.

9. The polymer composition of claim 1, wherein the polymer composition is thermally stable up to at least 230° C. determined through a thermorheological method.

10. The polymer composition of claim 1, wherein the polymer composition has a density, measured according to ASTM D792, of 0.940 to 0.970 g/cm³.

11. The polymer composition of claim 1, wherein the polymer composition has a melt flow rate, measured according to ASTM D1238 at 190° C. and a load of 2.16 kg, of from 10 to 40 g/10 min.

12. The polymer composition of claim 1, wherein the polymer composition has a gel level count per unit area of less than 150 gels/m² for a CAT 1 class (201-500 μm), and less than 10 gels/m² for a CAT 2 class (501-1000 μm) and a gel level count per unit area of 0 gels/m² for a CAT 3 class and a CAT 4 class (greater than 1000 μm).

13. The polymer composition of claim 1, wherein the HDPE exhibits a bio-based carbon content as determined by ASTM D6866-18 Method B of at least 5%.

14. The polymer composition of claim 1, wherein at least a portion of ethylene from the HDPE is obtained from a renewable source of carbon.

15. A monocomponent fiber comprising the polymer composition of claim 1, wherein the monocomponent fiber comprises a circular, angular, lobal, serrated, oval, or ribbonlike configuration.

16. A method comprising, producing an article from the monocomponent fiber of claim 15, wherein the article is a non-woven article.

17. The method of claim 16, further comprising processing the polymer composition in a spun bonding process.

18. The method of claim 16, wherein the article comprises a fabric in a weight per unit area range of from 1 to 1000 g/m².

19. The method of claim 15, further comprising spinning the polymer composition into a filament; producing more than one filament; and depositing the filaments to form a web.

20. The method of claim 19, wherein the filaments have a linear mass density in a range of from 0.1 to 100 dtex.
